(19) United States
(12) Patent Application Publication
(10) Pub. No.: US 2010/0043821 A1
(43) Pub. Date: Feb. 25, 2010

(54) METHOD OF PHOTORESIST REMOVAL IN THE PRESENCE OF A LOW-K DIELECTRIC LAYER

(76) Inventors: Siyi Li, Fremont, CA (US); Ryan Patz, Albany, NY (US); Qingjun Zhou, Sunnyvale, CA (US); Jeremiah Pender, San Jose, CA (US); Michael D. Armacost, San Jose, CA (US)

Correspondence Address: APPLIED MATERIALS/BSTZ;BLAKELY SOKOLOFF TAYLOR & ZAFMAN LLP, 1279 OAKMEAD PARKWAY, SUNNYVALE, CA, 94085-4040, US

(21) Appl. No.: 12/193,964

(22) Filed: Aug. 19, 2008

(51) Int. Cl. B08B 6/00

(52) U.S. Cl. 134/1.2; 134/60

(57) ABSTRACT

Described herein are methods and apparatus for removing photoresist in the presence of low-k dielectric layers. In one embodiment, the method includes exciting a first mixture of gases having a ratio of a flow rate of reducing process gas to a flow rate of an oxygen-containing process gas that is between 1:1 and 100:1 to generate a first reactive gas mixture. Next, the method includes exposing the photoresist layer that overlays the low-k dielectric layer on a substrate to the first reactive gas mixture to selectively remove the photoresist layer from the dielectric layer. Next, the method includes exposing the photoresist layer to a second reactive gas mixture to selectively remove the photoresist layer from the dielectric layer. The first and second reactive gas mixtures contain substantially no ions when the substrate is exposed to these mixtures in order to minimize damage to the low-k dielectric layer.

### TECHNICAL FIELD

Embodiments of the present invention relate to photoresist removal in the presence of low dielectric constant (low-k) layers in a downstream plasma system.

### BACKGROUND

As semiconductor manufacturing technology advances to smaller and smaller feature sizes, porous low-k integration with Copper interconnect technology has been widely evaluated. Interconnect delay becomes a significant performance barrier for high-speed signal conduction. The use of dielectric materials with a lower dielectric constant can significantly improve performance measures by reducing signal propagation time delay, cross talk, and power consumption in semiconductor devices having a multilevel interconnect architecture. The most-used dielectric material for semiconductor fabrication has been silicon oxide (SiO₂), which has a dielectric constant in the range of k=3.9 to 4.5, depending on its method of formation. Dielectric materials with k less than 3.9 are classified as low-k dielectrics. Some low-k dielectrics are organosilicates formed by doping silicon oxide with carbon-containing compounds.

Integration of porous low-k layers has exerted significant challenges. First, a barrier metal (e.g., Tantalum Nitride, Tantalum) or even Copper penetration into the dielectric results in increased leakage and capacitance. Second, plasma processing during various well-known etching and/or stripping operations causes damage to porous low-k dielectric layers.

Etching the dielectric material and removing a photoresist layer may be performed with an O₂-containing plasma, which can degrade the dielectric properties of the dielectric material through oxidation. This damage to the material is believed to occur when Silicon (Si)-Carbon (C) bonds, methyl groups, are broken and hydrophilic hydroxyl (OH) groups replace the hydrophobic methyl groups. The polarity of the dielectric material is thus changed and the damaged dielectric more easily absorbs moisture, resulting in an increase of both leakage current and dielectric constant. Subsequent heating of the damaged dielectric material can release moisture, interfering with the process of filling the etched cavities with metal. Semiconductor devices fabricated with such damaged dielectric material exhibit reduced performance measures and increased fabrication defects compared to devices fabricated with undamaged dielectric material.

### SUMMARY

Methods and apparatus are described for removing photoresist in the presence of low-k dielectric layers. In one embodiment, the method includes exciting a first mixture of gases having a ratio of a flow rate of reducing process gas to a flow rate of an oxygen-containing process gas that is between 1:1 and 100:1 to generate a first reactive gas mixture. Next, the method includes exposing the photoresist layer that overlays the low-k dielectric layer on a substrate to the first reactive gas mixture to selectively remove the photoresist layer from the dielectric layer. Next, the method includes exposing the photoresist layer to a second reactive gas mixture to selectively remove the photoresist layer from the dielectric layer. The first and second reactive gas mixtures contain substantially no ions when the substrate is exposed to these mixtures in order to minimize damage to the low-k dielectric layer.

### BRIEF DESCRIPTION OF THE DRAWINGS

Embodiments of the present invention are illustrated by way of example, and not by way of limitation, in the figures of the accompanying drawings and in which:

FIG. 1 illustrates one embodiment of a method for removing a photoresist layer in the presence of a low-k dielectric layer;

FIG. 2A illustrates a cross-sectional view of an interconnect structure fabricated to form a via in accordance with one embodiment;

FIG. 2B illustrates a cross-sectional view of an interconnect structure fabricated to form a via in accordance with another embodiment;

FIG. 2C illustrates a cross-sectional view of an interconnect structure fabricated to form a via in accordance with another embodiment;

FIG. 3A illustrates a cross-sectional view of an interconnect structure fabricated to form a trench in accordance with another embodiment;

FIG. 3B illustrates a cross-sectional view of an interconnect structure fabricated to form a trench in accordance with another embodiment;

FIG. 3C illustrates a cross-sectional view of an interconnect structure fabricated to form a trench in accordance with another embodiment;

FIG. 3D illustrates a cross-sectional view of an interconnect structure fabricated to form a trench in accordance with another embodiment;

FIG. 3E illustrates a cross-sectional view of a dual-damascene structure fabricated in accordance with one embodiment;

FIG. 3F illustrates a cross-sectional view of a dual-damascene structure fabricated in accordance with another embodiment;

FIG. 3G illustrates a cross-sectional view of a dual-damascene structure fabricated in accordance with another embodiment;

FIG. 3H illustrates a cross-sectional view of a dual-damascene structure fabricated in accordance with another embodiment;

FIG. 4 illustrates one embodiment of an apparatus for photoresist and residue removal;

FIG. 5 illustrates another embodiment of an apparatus for photoresist and residue removal;

FIG. 6 illustrates another embodiment of an apparatus for photoresist and residue removal;

FIG. 7 illustrates a cross-sectional view of a trench structure after a trench etch in accordance with one embodiment; and

FIG. 8 illustrates a cross-sectional view of the trench structure illustrated in FIG. 7 after a resist removal in accordance with one embodiment.

### DETAILED DESCRIPTION

Described herein are exemplary methods and apparatuses for removing photoresist and other organic layers in the presence of dielectric layers, in particular, low-k dielectric layers. In one embodiment, a method includes exciting a first mixture of gases having a ratio of a flow rate of reducing process gas to a flow rate of an oxygen-containing process gas to generate a first reactive gas mixture including reactive radical species, ions, and electrons. Next, the method includes flowing the first excited reactive gas mixture into a settling cavity. The ions combine with the electrons while the first reactive gas mixture is within the settling cavity. Next, the method includes exposing a photoresist layer that overlays a low-k dielectric layer on a substrate to the first reactive gas mixture to selectively remove the photoresist layer from the dielectric layer. In some embodiments, the reducing process gas is H₂ and the oxygen-containing process gas is vaporized water. The first reactive gas mixture contains substantially no ions when the substrate is exposed to the first reactive gas mixture in order to minimize damage to the low-k dielectric layer and any other exposed layers. Also, the first gas mixture with the reducing processing gas causes minimal damage to the low-k dielectric layer and any other exposed layers.

In another embodiment, the method includes exciting a second mixture of gases including a reducing process gas and a non-H₂O containing gas such as an inert process gas to generate a second reactive gas mixture including reactive radical species, ions, and electrons. Next, the method includes flowing the second excited reactive gas mixture into the settling cavity. The ions combine with the electrons while the second reactive gas mixture is within the settling cavity. Next, the method includes exposing the photoresist layer overlaying the low-k dielectric layer on the substrate to the second reactive gas mixture to selectively remove the photoresist layer from the low-k dielectric layer. In certain embodiments, the reducing process gas is H₂ and the inert process gas is helium. The second reactive gas mixture contains substantially no ions when the substrate is exposed to the second reactive gas mixture. The second gas mixture with the reducing processing gas causes substantially no damage to the low-k dielectric layer and any other exposed layers.

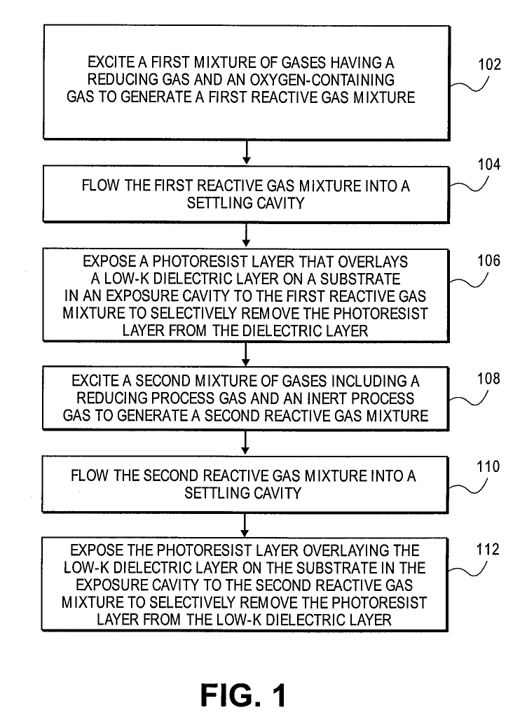

FIG. 1 illustrates one embodiment of a method for removing a photoresist layer in the presence of a low dielectric constant (low-k) dielectric layer disposed on a substrate in a process chamber. The method includes exciting a first mixture of gases having a reducing gas and an oxygen-containing gas to generate a first reactive gas mixture including reactive radical species, ions, and electrons at block 102. The reducing and oxygen-containing gas mixtures have a ratio of between 1:1 and 100:1 for a flow rate of the reducing process gas (e.g., hydrogen gas, ammonia gas, an alkane, and an alkene) to a flow rate of the oxygen-containing process gas (e.g., vaporized water, oxygen gas, carbon monoxide gas, carbon dioxide gas, alcohol vapor). Next, the method includes flowing the first reactive gas mixture into a settling cavity at block 104. The ions combine with the electrons while the first reactive gas mixture is within the settling cavity. Next, the method includes exposing the photoresist layer that overlays the low-k dielectric layer on the substrate in an exposure cavity to the first reactive gas mixture to selectively remove the photoresist layer from the dielectric layer at block 106. In one embodiment, the settling cavity is located remotely from the exposure cavity having the substrate with the first reactive gas mixture flowing through openings in the settling cavity through a coupling region. The settling cavity can be about 10 to 100 centimeters (cm) remotely locating from the exposure cavity. The first reactive gas mixture is substantially electrically neutral, not substantially affected by an electric field, and contains substantially no ions when it reaches the substrate because the exposure cavity is downstream from the settling cavity in order to minimize damage to the low-k dielectric layer and any other exposed layers. A higher ratio of reducing process gas to oxygen-contain process gas reduces damage to the low-k dielectric layer but also decrease the etch rate of the photoresist layer.

In an embodiment, the reducing process gas is H₂ and the oxygen-containing process gas is vaporized water. The oxidizing process gas (e.g., vaporized water, oxygen gas, carbon monoxide gas, carbon dioxide gas, alcohol vapor) substantially increases the rate of photoresist removal when compared with the reducing process gas alone.

In another embodiment, the method includes exciting a second mixture of gases including a reducing process gas and a non-H₂O gas such as an inert process gas to generate a second reactive gas mixture that includes reactive radical species, ions, and electrons at block 108. Next, the method includes flowing the second reactive gas mixture into the settling cavity at block 110. The ions combine with the electrons while the second reactive gas mixture is within the settling cavity to form a gas mixture that is substantially electrically neutral, not substantially affected by an electric field, and contains substantially no ions. Next, the method includes exposing the photoresist layer overlaying the low-k dielectric layer on the substrate in the exposing cavity to the second reactive gas mixture to selectively remove the photoresist layer from the low-k dielectric layer at block 112.

In certain embodiments, the reducing process gas is H₂ and the inert process gas includes may be helium, argon, and/or xenon. Increasing the volume of inert gas in the second reactive gas mixture will increase the etch rate of the photoresist layer. The first reactive gas mixture can be used for the main etch operation with minimal damage to the low-k dielectric layer and the second reactive gas mixture can be used for the over etch operation with substantially no damage to the low-k dielectric layer while removing the photoresist layer.

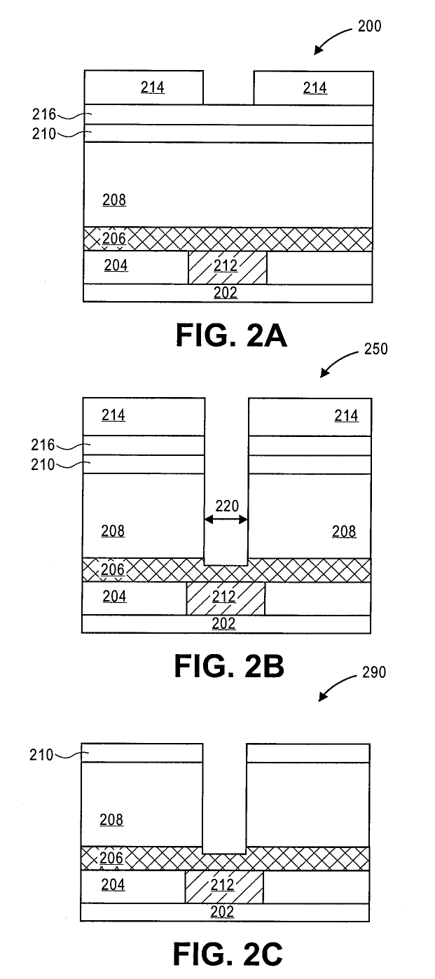

FIG. 2A illustrates a cross-sectional view of an interconnect structure 200 fabricated to form a via in accordance with one embodiment. The interconnect structure 200 includes a substrate 202, a dielectric layer 204 (e.g., thermal oxide, low temperature oxide, TEOS, doped oxide, etc), a metal layer 212 (copper, aluminum copper), an etch stop layer 206 (e.g., non-conductive material, SiC based film, SiCN based film), a porous low-k dielectric layer 208, a masking layer 210 (e.g., low temperature oxide, organic layer, TEOS) to be used as a hard mask during the low-k dielectric etch, an optional anti-reflective coating (ARC) layer 216 to minimize the reflectance of underlying layers, and a resist layer 214.

In one embodiment, the low-k dielectric layer 208 has a dielectric constant less than 2.3, a porosity greater than twenty percent, and contains greater than ten percent Carbon. The low-k dielectric layer 208 has a thickness of about 3000 A to about 10000 A. The porous low-k dielectric layer has a density and pores of a certain size (e.g., about 5 to 20 Angstroms). For example, the porous low-k dielectric layer can be a pyrogenic film, a carbon doped oxide, or other type of dielectric layer having a low or ultra low-k. The resist layer 214 may be a photosensitive photoresist layer that is blanket coated or deposited across the interconnect structure, masked, exposed to a light source, and developed to form via openings in accordance with standard photolithography operations. The masking layer 210 may have a thickness of about 300 A to 2000 A.

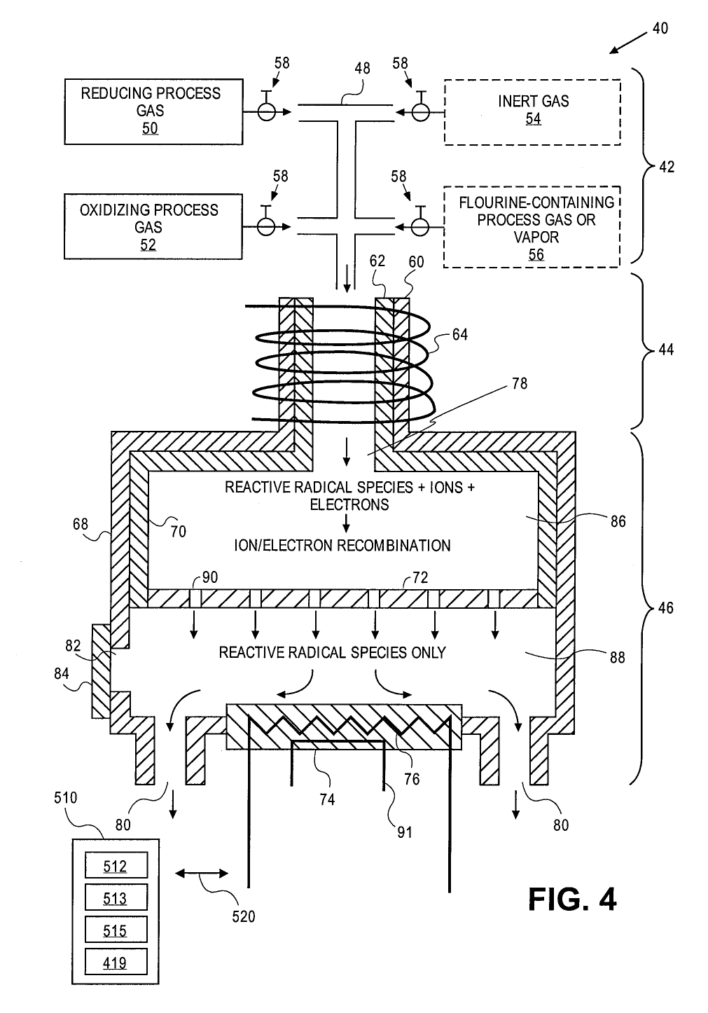

FIG. 2B illustrates a cross-sectional view of an interconnect structure 250 fabricated to form a via in accordance with another embodiment. The interconnect structure 250 of FIG. 2B illustrates the interconnect structure 200 of FIG. 2A after a via etch that results in the formation of the via 220. The ARC layer 216, the masking layer 210 (e.g., low temperature oxide, organic layer, TEOS) and the porous low-k dielectric layer 208 are etched until reaching the etch stop layer 206 to form the via 220. The interconnect structure 250 is then loaded into a resist removal apparatus as illustrated in FIGS. 4-6 and described below in order to remove the resist layer 214 and the ARC layer 216 without damaging the low-k dielectric layer 208.

FIG. 2C illustrates a cross-sectional view of an interconnect structure 290 fabricated to form a via in accordance with another embodiment. The interconnect structure 290 of FIG. 2C illustrates the interconnect structure 250 of FIG. 2B after the ARC layer 216 and the resist layer 214 have been removed with a plasma ashing operation that results in the formation of the via 220 without damaging the low-k dielectric layer 208. The interconnect structure 290 is exposed to a first reactive gas mixture in the resist removal apparatus. The first reactive gas mixture includes a reducing process gas and oxygen-containing process gas. In one embodiment, a ratio of a flow rate of the reducing process gas to a flow rate of the oxygen-containing process gas is between 1:1 and 100:1 to selectively remove the photoresist layer 214 from the interconnect structure 290 without damaging the underlying layers during a main etch operation.

In an embodiment, the reducing process gas is H₂ and the oxygen-containing process gas is vaporized water. In a specific embodiment with H₂ gas and vaporized water, the gas mixture removes the photoresist layer at a rate of approximately 1.5 microns/minute with a 5000 standard cubic centimeters per minute (sccm) flow rate of H₂, a 90 sccm flow rate of vaporized water, a process chamber pressure of 50 mTorr to 3000 mTorr, a substrate temperature greater than 150 degrees C. (e.g., 250 degrees C.), and a RF power source of 4000 to 6000 watts.

The interconnect structure 290 is further exposed to a second reactive gas mixture including a mixture of H₂ gas and another gas with no H₂O such as an inert process gas (e.g., argon, helium, xenon) to selectively remove the photoresist layer from the interconnect structure 290 during an over etch operation.

In a specific embodiment, the second reactive gas mixture removes the photoresist layer at an etch rate of 600 Angstroms per minute with a total gas flow rate between 2,500 and 12,500 sccm (e.g., 7500 sccm of helium gas, 1500 sccm of H₂ gas), a helium to hydrogen gas ratio between 1:1 and 10:1, a process chamber pressure of 50 mTorr to 3000 mTorr, a substrate temperature greater than 150 degrees C. (e.g., 250 degrees C.), and a RF power source of 4000 to 6000 watts.

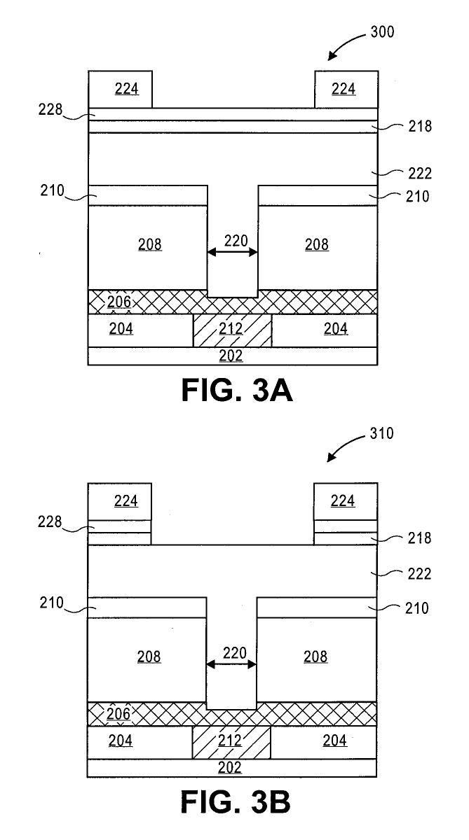

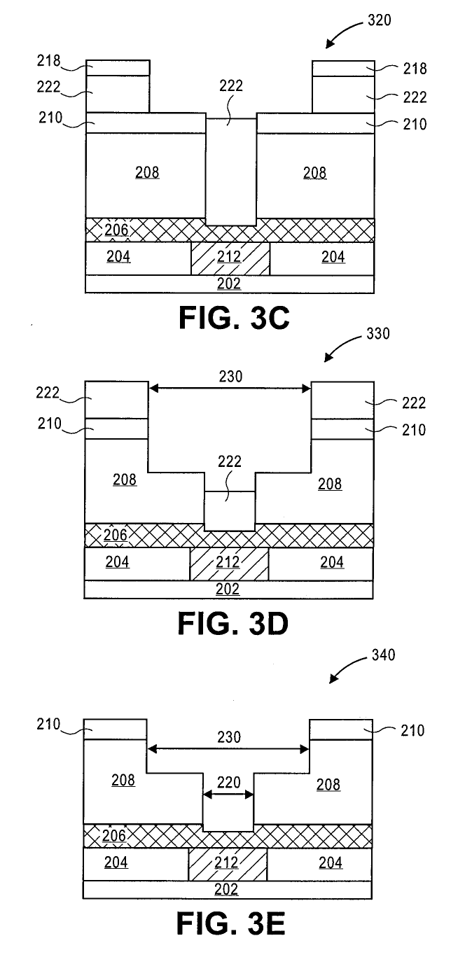

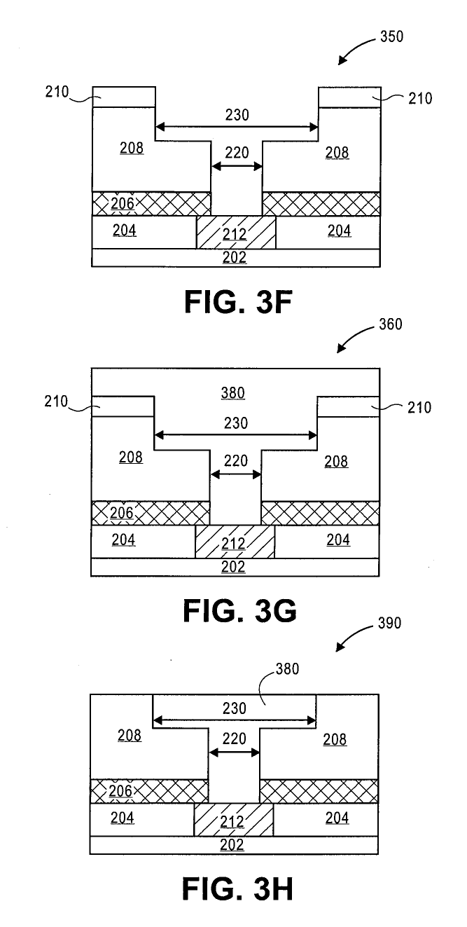

FIG. 3A illustrates a cross-sectional view of an interconnect structure 300 fabricated to form a trench in accordance with another embodiment. The interconnect structure 300 includes a sacrificial light absorbing layer 222, an optional oxide layer 218 (e.g., LTO), an optional ARC layer 228, and a resist layer 224 in addition to the layers illustrated in the interconnect structure 290. The interconnect structure 300 can also be formed independently as a trench etch without the via etch and resist strip operations illustrated in FIGS. 2A-2C. The sacrificial layer 222 may include an organic sacrificial layer (e.g., ARC, spin on glass (SOG) such as phosphosilicates or siloxanes) and zero or more dielectric layers. The sacrificial layer 222 fills the via 220 and planarizes variations in the film stack thickness across the substrate 202. The resist layer 224 is patterned with a trench mask, exposed to a light source, and the exposed or unexposed portions of the photoresist are dissolved with a photoresist developer to form trench openings in the resist layer 224.

FIG. 3B illustrates a cross-sectional view of an interconnect structure 310 fabricated to form a trench in accordance with another embodiment. The interconnect structure 310 of FIG. 3B illustrates the interconnect structure 300 of FIG. 3A after a hard mask etch of the optional ARC layer 228 and the optional oxide layer 218.

FIG. 3C illustrates a cross-sectional view of an interconnect structure 320 fabricated to form a trench in accordance with another embodiment. The interconnect structure 320 of FIG. 3C illustrates the interconnect structure 310 of FIG. 3B after the sacrificial layer 222 is partially etched to form a trench opening. The resist layer 224 and ARC layer 228 are also removed during this etch with the oxide layer 218 and masking layer 210 being etch stop layers.

FIG. 3D illustrates a cross-sectional view of an interconnect structure 330 fabricated to form a trench in accordance with another embodiment. The interconnect structure 330 of FIG. 3D illustrates the interconnect structure 320 of FIG. 3C after a trench etch of the masking layer 210, low-k dielectric layer 208, and sacrificial layer 222 that result in the formation of the trench 230. The oxide layer 218 which acts as a masking layer is also etched during the trench etch.

FIG. 3E illustrates a cross-sectional view of a dual-damascene interconnect structure 340 fabricated in accordance with another embodiment. The interconnect structure 340 of FIG. 3E illustrates the interconnect structure 330 of FIG. 3D after a plasma strip or ashing of the sacrificial layer 222 to form the trench and the via. The exposed surface of the etch stop layer 206 is partially etched during the plasma strip or ashing. The interconnect structure 330 is loaded into the resist removal apparatus (e.g., apparatus 40) in order to remove the sacrificial layer 222 without damaging the low-k dielectric layer 208.

The interconnect structure 360 is exposed to a first reactive gas mixture in the apparatus 40. The first reactive gas mixture includes a reducing process gas and oxygen-containing process gas. In one embodiment, a ratio of a flow rate of the reducing process gas to a flow rate of the oxygen-containing process gas is between 1:1 and 100:1 to selectively remove the sacrificial layer 222 from the interconnect structure 330 without damaging the underlying layers.

In one embodiment, the reducing process gas is H₂ and the oxygen-containing process gas is vaporized water. In a specific embodiment with H₂ gas and vaporized water, the gas mixture removes the sacrificial layer 222 at a rate of approximately 1.5 microns/minute with a 5000 standard cubic centimeters per minute (sccm) flow rate of H₂, a 90 sccm flow rate of vaporized water, a process chamber pressure of 50 mTorr to 3000 mTorr, a substrate temperature greater than 150 degrees C. (e.g., 250 degrees C.), and a RF power source of 4000 to 6000 watts.

The interconnect structure 330 is further exposed to a second reactive gas mixture including a mixture of H₂ gas and another gas with no H₂O such as an inert process gas (e.g., argon, helium, xenon) to selectively remove the sacrificial layer 222 from the interconnect structure. In a specific embodiment, the second reactive gas mixture removes the sacrificial layer 222 at an etch rate of 600 Angstroms per minute with a total gas flow rate between 2,500 and 12,500 sccm (e.g., 7500 sccm of helium gas, 1500 sccm of H₂ gas), a helium to hydrogen gas ratio between 1:1 and 10:1, a process chamber pressure of 50 mTorr to 3000 mTorr, a substrate temperature greater than 150 degrees C. (e.g., 250 degrees C.), and a RF power source of 4000 to 6000 watts.

FIG. 3F illustrates a cross-sectional view of a dual-damascene interconnect structure 350 fabricated in accordance with another embodiment. The interconnect structure 350 of FIG. 3F illustrates the interconnect structure 340 of FIG. 3E after the exposed surface of the etch stop layer 206 is etched until reaching the metal layer 212. A post etch operation is also performed to clean the exposed surfaces of the interconnect structure 350.

FIG. 3G illustrates a cross-sectional view of a dual damascene structure 360 in accordance with another embodiment. A metal layer 380 (e.g., copper, aluminum copper) is blanket deposited or plated onto the interconnect structure 350 to form the interconnect structure 360. The vias and trenches are filled with the metal layer 380. A barrier metal layer (e.g., Ti, TiN, Ta, TaN), not shown, may optionally be deposited prior to the deposition of the metal layer 380. The barrier metal layer prevents the diffusion of metal from the metal layer into other materials such as the low-k dielectric layer.

FIG. 3H illustrates a cross-sectional view of a dual-damascene structure 390 fabricated in accordance with another embodiment. In one embodiment, a top surface of the metal layer 380 is removed using standard semiconductor processing operations such as etching. In one embodiment, a chemical-mechanical planarization process etches a top surface of a metal layer 380 disposed on the interconnect structure 390. The metal layer 380 and masking layer 210 are etched until reaching the porous dielectric layer 208 resulting in the interconnect structure 390. The masking layer 210 having a higher dielectric constant in comparison to the porous dielectric layer 208 may be completely removed in order to minimize the dielectric constant of the interconnect structure 390. In some embodiments, the planarization process stops etching upon reaching the masking layer 210 thus leaving a portion of the masking layer 210. The at least one via 220 and at least one trench 230 have been filled with the metal layer 380 (e.g., Cu plating, AlCu deposition).

In one embodiment, the interconnect structures described herein illustrate a dual-damascene process having at least one via 220 and at least one trench 230 formed from semiconductor deposition, lithography, etch, strip, and planarization operations. Dual-damascene forms studs and interconnects with one metallization operation. The dual-damascene process increases the density, performance, and reliability in a fully integrated wiring technology. In another embodiment, the interconnect structure 300 is a single damascene structure or other structure that forms an opening in a porous dielectric layer.

The interconnect structures can be fabricating with the apparatuses described herein which are suitable for processing substrates 202 such as semiconductor substrates, and may be adapted by those of ordinary skill to process other substrates 202 such as flat panel displays, polymer panels or other electrical circuit receiving structures. Thus, the apparatuses should not be used to limit the scope of the invention, nor its equivalents, to the exemplary embodiments provided herein.

FIG. 4 illustrates an exemplary photoresist and residue removal apparatus 40 that may be used for carrying out the method according to the invention. The apparatus 40 includes a gas supply apparatus 42, an apparatus 44 for energizing the gas mixture, and a substrate processing apparatus 46. The gas supply apparatus 42 includes a supply line 48, a source of a reducing process gas 50, a source of an oxidizing process gas 52, optionally a source of fluorine-containing process gas or vapor 56, and a source of one or more inert gases 54. A respective valve 58 connects a respective source 50, 52, 54, and 56 to the supply line 48. The apparatus 44 generates reactive radical species, according to the exemplary embodiment, by creating reactive species by coupling the gas mixture with an electromagnetic field that is remote from the substrate. The apparatus generally includes a pass-through pipe 60, a quartz liner 62 on an inner surface of the pipe 60, and a coil 64 that spirals around the pipe 60. The supply line 48 feeds into an upper end of the pipe 60. The center of the coil 64 is located within the pipe 60. The material of the pipe 60 and the quartz of the quartz liner 62 allow for the electromagnetic field to be created within pipe 60 although the coil 64 is located external to the pipe 60. In the exemplary embodiment reactive species are created by energizing a mixture of gases with a radio frequency inductively coupled plasma. A microwave source may alternatively be used creating a microwave-coupled plasma. A capacitive source may also be used by creating a capacitively-coupled plasma. Furthermore, a capacitively-coupled plasma may be generated directly above the substrate by powering a substrate stand 74 and grounding the chamber walls and optionally a baffle 72. The energized gas mixture may be created by the remote source, capacitively coupling to the substrate stand only, or by simultaneously using the remote source and capacitively-coupling to the substrate stand. It is also possible to utilize a toroidal radio-frequency-based source to create a radio frequency inductively coupled plasma. Other apparatuses may exist that can generate reactive radical species out of a mixture as described.

The substrate processing apparatus 46 according to the exemplary embodiment includes a processing chamber 68, a liner 70 (e.g., quartz), a baffle 72, a substrate stand 74, a resistive element 76, and a cooling line 91. For capacitive-coupling to the substrate stand 74, a heat exchanger may replace the cooling line 91. As can be understood, coating of walls 60 and 68 may be used instead of liners 62, 70. A processing chamber 68 has an inlet opening 78 in an upper wall thereof and outlet openings 80 in a lower wall thereof. The chamber 68 also has a slit 82 in one sidewall thereof. The slit 82 can be opened and closed with a slit valve 84. The quartz liner 70 is located on the upper walls of the processing chamber 68 and on sidewalls of the processing chamber 68. Optionally, a liner or coating may be added to the lower walls of the chamber 68.

The baffle 72 is located between the upper wall and the lower wall and separates the chamber 68 into a settling cavity 86 and an exposure cavity 88. The baffle 72 may separate the settling cavity 86 and exposure cavity by a certain distance (e.g., 10 to 100 cm). Alternatively, the baffle may be replaced with a single pathway that separates the settling cavity 86 and exposure cavity 88 by a fixed distance (e.g., 10 to 100 cm). The baffle 72 is entirely made of quartz and has a plurality of baffle openings 90 formed therein. For generating a capacitively-coupled electric field above the substrate, RF-power is supplied to the substrate stand 74; the baffle 72 may be embedded with a conductive material or may be replaced entirely with a conductive material such as aluminum which is grounded to the walls off the chamber. Alternatively, the baffle 72 may be RF-powered to generate a softer-bias above the wafer.

A lower end of the pipe 60 feeds into the inlet opening 78 of the processing chamber 68. A gas can flow from the supply line 48 through the pipe 60 into the settling cavity 86 and then through the baffle openings 90 into the exposure cavity 88 of the processing chamber 68. The gas is only exposed to containing walls formed by the quartz liner 62, the quartz liner 70, and the quartz of the baffle 72 from when the gas enters the pipe 60 until when the gas exits through the baffle openings 90 into the exposure cavity 88.

The substrate stand 74 is located within the lower wall of the processing chamber 68 and has an upper horizontal surface located within the exposure cavity 88 of the processing chamber 68. A substrate (not shown) can be located on the upper horizontal surface of the substrate stand 74. The resistive element 76 is located within the substrate stand 74. A current flowing through the resistive element 76 heats the substrate stand 74 and the upper surface thereof.

In various embodiments, photoresist removal or stripping processes are be obtained when the apparatuses 44 and 46 are conditioned by pre-heating. As will be discussed below, it is believed that the reactivity between the quartz and the energized gas mixture is significantly reduced within the apparatuses 44 and 46. It is also believed that such reactivity is reduced further when the quartz liners 62 and 70 and the quartz of the baffle 72 are preheated. Minimal reactivity from bulk or surface recombination reactions increases the quantity of reactive species available to react with the substrate.

First, substrates are removed from the exposure cavity 88 through the slit 82 and the slit valve 84 is closed. The valves 58 provided at the gas supply apparatus 72 are opened so that at least the gases 50 and 52 flow into the supply line 48 where they mix. The gas mixture then flows through the supply line 48 into the upper end of the pipe 60. The electromagnetic field then energizes the molecules of the gases of the mixture. Molecules are dissociated and ionized to generate a complex mixture of neutral radicals, ions, and electrons. Energy is dissipated from the mixture to the quartz liner 62. The energized gas mixture then flows through the inlet opening 78 into the settling cavity 86. Additional energy is dissipated from the mixture to the liner 70 and to the baffle 72. The mixture then flows through the baffle openings 90 into the exposure cavity 88, reacts with the substrate, and then flows out of the outlet openings 80.

It can thus be seen that the combination of the gases 50 and 52 together with an electromagnetic field 64 transfers thermal energy to liners 62 and 70 and the baffle 72. These components are preferably heated to a surface temperature of at least 400 degrees Celsius (C). Alternatively or additionally, heating coils or lamps may be used to heat the walls and liners. The gas mixture composition is preferably similar or identical to the composition used during photoresist removal. Alternatively the gas mixture may be primarily an oxygen-containing mixture which may optionally include a minority component of nitrogen, a reducing gas, or a fluorine containing gas. In one embodiment, this alternative mixture provides the pre-heating requirements as well as, serves as a method for dry chamber cleaning of excess organic and inorganic residue that deposits on the chamber surfaces over many wafers.

Current is also provided through the resistive element 76 so that the resistive element heats the substrate stand 74. A cooling fluid in the cooling line 91 maintains the temperature of the substrate stand 74 at a desired level. In the exemplary embodiment, the substrate stand 74 is heated to a temperature above 120 degrees C. in order to generate the thermal energy required to sustain production-worthy photoresist removal rates. The substrate stand 74 is however not heated to a temperature above 500 degrees C. For alternative embodiments with RF-bias to the substrate, the thermal activation energy requirement is replaced with ion-bombardment, allowing the temperature to be substantially reduced to a minimum temperature of 20 degrees C. For these alternative embodiments a heat exchanger may replace the resistive element and still provide adequate heating. When the liners 62 and 70 and the baffle 72 reach a surface temperature of 400 degrees C. and the substrate stand 74 reaches a temperature of between 150 degrees C. and 400 degrees C. (for example, 250 degrees C.), the valves 58 are closed and current to the coil 64 is switched off. The chamber 68 is then filled with an inert gas. For purposes of further discussion it should be assumed that these temperatures are maintained throughout further processing.

When the slit valve 84 is moved, the slit 82 is opened. The substrate 202, which can be located on a blade and carried on the blade, is placed through the slit valve 84 and into the exposure cavity 88. The blade positions the substrate 202 on the upper surface of the substrate stand 74. The blade is thereafter removed through the slit valve 84 and the slit 82 is closed by the slit valve 84. Heat transfers from the resistive element 76 to the substrate stand 74 and from the substrate stand 74 to substrate. The heat transfers from the substrate through the dielectric layer to the photoresist layer (e.g., the substrate can be the substrate 202 having the dielectric layer 208 and the photoresist layer 214, 224 as previously described). The photoresist layer is heated to a temperature of between 150 degrees C. and 400 degrees C. (for example, 250 degrees C.).

An alternating current is provided through the coil 64. The alternating current in the coil 64 creates a radio frequency field within a core of the pipe 60. The valves 58 are subsequently opened so that the reducing process gas 50 and the oxidizing process gas 52 flow into and mix in the supply line 48. The mixture of gases then flows from the supply line through the pipe 60 and the chamber 68 out of the outlet openings 80. A pump is connected to the outlet openings 80 which maintains a pressure within the chamber 68 at between 50 mTorr and 3 Torr (e.g., 1 Torr). In an embodiment, a ratio of a flow rate of reducing process gas 50 to a flow rate of an oxygen-containing process gas 50 is between 1:1 and 100:1 for a main etch operation that strips a photoresist layer in the presence of a low-k dielectric layer. The reducing process gas 50 flows at a rate of between 200 standard cubic centimeters per minute (sccm) and 10000 sccm (e.g., 5000). The reducing process gas 50 may for example be hydrogen, ammonia, an alkane such as methane, ethane, or isobutane, an alkene such as ethylene or propylene, or any combination of these gases. The oxidizing process gas 52 forms approximately 1% to 50% by volume of the mixture with a flow rate of 10 sccm to 3500 sccm. The oxidizing process gas may for example be water vapor, oxygen, carbon monoxide, or an alcohol.

The mixture flows from the supply line 48 into the pipe 60. The electromagnetic field within the core of the pipe 60 energizes the molecules of the gas in a number of ways. First, the molecules are energized so as to cause more collisions between the molecules with a corresponding increase in temperature of the mixture. Second, the internal energy of the molecules is increased so that reactive radical species are created out of the molecules. Third, some electrons are added or subtracted from some of the molecules so that ions are also created from some of the molecules and free electrons also exist within the mixture.

The mixture at its increased temperature and including the reactive radical species, ions, electrons and neutrals then flows through the inlet opening 78 into the settling cavity 86. The ions combine rapidly with the electrons while the mixture is within the settling cavity 86. A result of the ion-electron recombination is that the ion density is substantially reduced. The density of the radical species is also reduced, although to a much lesser degree than the ions, because of surface and bulk recombination. The rate of recombination is decreased by the quartz of the liners 62 and 70 and the quartz of the baffle 72. As mentioned, the preferred oxidizing process gas 52 is water vapor. It has been found that photoresist removal rates with a reducing gas are substantially increased with only a small component of an oxidizing gas, particularly water vapor. It is believed that an oxidizing component substantially increases the generation and lifetime of the reactive radical species. Furthermore, it is believed that gas capable of hydrogen-bonding, particularly water vapor, can hydrogen bond with the quartz, effectively creating a reducing-rich surface. Reducing radicals that impinge the surface react with the surface and release another radical, thus regenerating the active radical density. It is believed further that high surface temperatures, preferably at least 400 degrees C., reduce the recombination rate even further. The mixture including the reactive radical species remaining therein then flows through the baffle openings 90 to the exposure cavity 88. Substantially no ions reach the exposure cavity 88. The reactive radical species then react with the material of the photoresist layer. The photoresist layer is primarily an organic polymer. It is believed that the reactive radical species react with the photoresist in a manner similar to high temperature combustion reactions. Organic layers such as BARC or the sacrificial layer 222 are also removed in a similar fashion. Organic residues from the etch process are also removed in a similar fashion. Polymeric molecules are reduced to low molecular weight molecules, primarily carbon dioxide and water. The volatile products are added to the mixture and pumped out of the outlet openings 80.

As mentioned earlier, carbon or hydrogen-containing materials such as methyl groups exist in the dielectric layer 208. However, there is insufficient oxygen in the mixture to substantially react with the organic component of the dielectric. Furthermore, oxidizing gases such as water and alcohols can hydrogen-bond with the inorganic component of the dielectric and effectively protect the dielectric film with a hydrogen-rich passivation film. It can thus be seen that the reactive radical species remove the photoresist layer away but without causing damage to the dielectric layer 208. In addition, a reducing environment avoids oxidation of metals, particularly copper, that may be exposed during the treatment.

In one embodiment, the apparatus 40 illustrated in FIG. 4 includes a substrate processing apparatus 46 that includes a settling cavity 86 and an exposure cavity 88 having a substrate support 74 to receive a substrate 202 (not shown in FIG. 4) including a photoresist layer (e.g., 224, 214) overlying a low dielectric constant (k) dielectric layer (e.g., 208). The apparatus 40 further includes a gas supply apparatus 42 to distribute a first mixture of gases having a ratio of a flow rate of reducing process gas 50 to a flow rate of an oxygen-containing process gas 52 that is between 1:1 and 100:1 to generate a first reactive gas mixture including reactive radical species, ions, and electrons in the settling cavity 86 at a remote location with respect to the exposure cavity (e.g., about 10 to 100 cm distance apart). The apparatus 40 further includes an apparatus for generating radical species 44 to energize the first mixture of gases including reactive radical species, ions, and electrons in the settling cavity 86.

In one embodiment, the settling cavity 86 is located above the exposure cavity 88 having the substrate 202. The first reactive gas mixture flows through openings in the settling cavity 86 onto the substrate 202 to selectively remove the photoresist layer from the dielectric layer. The first reactive gas mixture contains substantially no ions when the substrate is exposed to the first reactive gas mixture.

In some embodiments, the reducing process gas is H₂ and the oxygen-containing process gas is vaporized water. The gas supply apparatus 42 further distributes a second mixture of gases including a reducing process gas and an inert process gas and the apparatus for generating radical species 44 energizes the second reactive gas mixture including reactive radical species, ions, and electrons in the settling cavity 86. In this case, the second reactive gas mixture flows through openings in the settling cavity 86 onto the substrate 202 to selectively remove the photoresist layer from the dielectric layer with the second reactive gas mixture containing substantially no ions when the substrate is exposed to the first reactive gas mixture. In one embodiment, the second reactive gas mixture includes a mixture of H₂ gas and another gas with no H₂O such as an inert process gas (e.g., argon, helium, xenon).

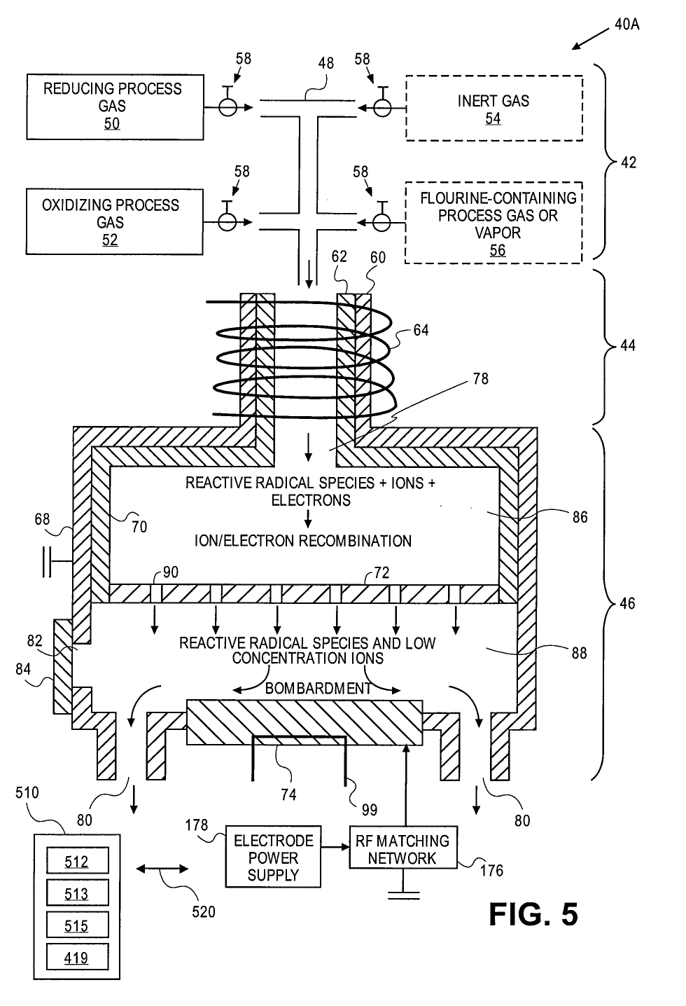

FIG. 5 illustrates a stripping apparatus 40A according to one alternative embodiment. No heater is provided within the stand 74 but a heat exchanger 99 controls the temperature. Instead, a radio-frequency (RF) matching network 176 is connected to the stand 74. An electrode power supply 178 is connected to the RF matching network 176 to provide power thereto. Both the chamber 68 and the baffle 72 are grounded. The biasing arrangement 176, 178 generates a low concentration of ions in the exposure cavity 88. The concentration of the ions created by the biasing arrangement 176, 178 is sufficiently high so as to, together with the reactive radical species, strip the photoresist layer. The concentration of the ions is however sufficiently low so as not to cause substantial damage to the low-k dielectric material.

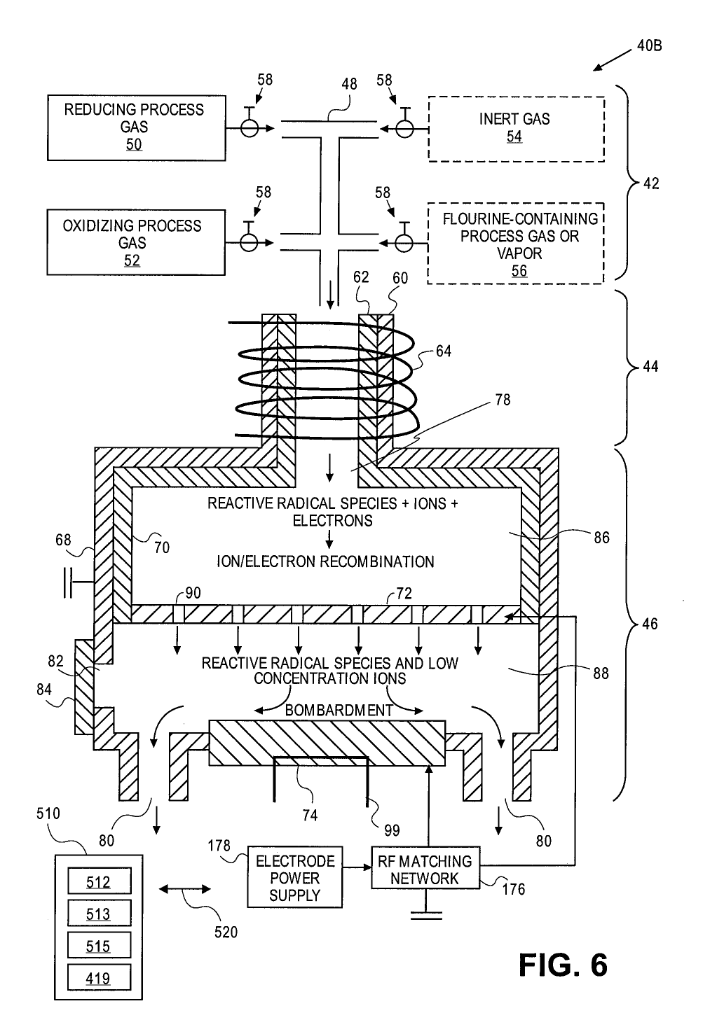

In the embodiment of FIG. 5, a bias is created between the stand 74 and the baffle 72. Because of the bias, the ions are accelerated towards the substrate located on the stand 74, and thus bombard the substrate. To reduce bombardment of the substrate, the apparatus 40A may be modified to the apparatus 40B shown in FIG. 6. In the apparatus 40B, the RF matching network 176 is also connected to the baffle 72. A bias between the baffle 72 and the stand 74 can so be reduced, even to zero. By reducing the bias between the baffle 72 and the stand 74, the ions are not accelerated as much as with the apparatus 40A of FIG. 5, thus causing less bombardment of the substrate.

Although photoresist stripping has been described, it should be noted that the processes discussed herein may also be used for other purposes such as residue removal from sidewalls of trenches, openings or vias in dielectric layers, hard masks and so forth. The dielectric layers may have k values less than 3.9 (e.g., low k) or in some embodiments greater than or equal to 3.9 as well.

The apparatuses 40, 40A, and 40B illustrated in FIGS. 4-6 may be operated by a controller 510 including a computer that sends instructions via a hardware interface 520 (e.g., wired or wireless communication link) to operate the chamber components, for example, the gas supply apparatus 42, the apparatus 44 for energizing the gas mixture, and the substrate processing apparatus 46. The process conditions and parameters measured by the different detectors in the respective apparatuses 40, 40A, and 40B are sent as feedback signals by control devices such as the gas flow control valves, pressure monitor (not shown), throttle valve, and other such devices, and are transmitted as electrical signals to the controller 510. Although, the controller 510 is illustrated by way of an exemplary single controller device to simplify the description of present invention, it should be understood that the controller 510 may be a plurality of controller devices that may be connected to one another or a plurality of controller devices that may be connected to different components of the respective apparatuses 40, 40A, and 40B. Thus, the present invention should not be limited to the illustrative and exemplary embodiments described herein.

The controller 510 includes electronic hardware including electrical circuitry including integrated circuits that are suitable for operating the respective apparatuses 40, 40A, and 40B and their peripheral components. Generally, the controller 510 is adapted to accept data input, run algorithms, produce useful output signals, detect data signals from the detectors and other chamber components, and to monitor or control the process conditions in the respective apparatuses 40, 40A, and 40B. For example, the controller 510 may include a computer including (i) a central processing unit (CPU) 512, such as for example, a conventional microprocessor, that is coupled to a memory 513 that includes a removable storage medium, such as for example a CD or floppy drive, a non-removable storage medium, such as for example a hard drive or ROM, and RAM; (ii) application specific integrated circuits (ASICs) that are designed and preprogrammed for particular tasks, such as retrieval of data and other information from the respective apparatuses 40, 40A, and 40B, or operation of particular chamber components; and (iii) interface boards that are used in specific signal processing tasks, including, for example, analog and digital input and output boards, communication interface boards and motor controller boards. The controller interface boards, may for example, process a signal from a process monitor and provide a data signal to the CPU. The computer also has support circuitry that include for example, co-processors, clock circuits, cache, power supplies and other well known components that are in communication with the CPU. The RAM can be used to store the software implementation of the present invention during process implementation. The instruction sets of code 515 of the present invention are typically stored in storage mediums and are recalled for temporary storage in RAM when being executed by the CPU.

In one embodiment, the controller 510 includes computer program instructions 515 that are readable by the computer and may be stored in the memory 513, for example on the non-removable storage medium or on the removable storage medium. The computer program instructions 515 generally includes process control software including program code including instructions to operate the chamber and its components, process monitoring software to monitor the processes being performed in the respective apparatuses 40, 40A, and 40B, safety systems software, and other control software.

In some embodiments, the controller 510 is operatively coupled to the respective apparatuses 40, 40A, and 40B. In a specific embodiment for a resist strip in the presence of the low-k dielectric layer, the controller 510 includes program code instructions 515 to operate the gas distributor to introduce into the respective apparatuses 40, 40A, and 40B a first reactive gas mixture that includes a reducing process gas and oxygen-containing process gas having a ratio of a flow rate of the reducing process gas to a flow rate of the oxygen-containing process gas that is between 1:1 and 100:1. The first reactive gas mixture selectively removes a photoresist layer without damaging the underlying layers during a main etch operation.

In one embodiment, the reducing process gas is H₂ and the oxygen-containing process gas is vaporized water. In a specific embodiment with H₂ gas and vaporized water, the program code instructions 515 include instructions that cause the gas distributor to introduce a gas mixture that removes the photoresist layer at a rate of approximately 1.5 microns/minute with a 5000 standard cubic centimeters per minute (sccm) flow rate of H₂, a 90 sccm flow rate of vaporized water, a process chamber pressure of 50 mTorr to 3000 mTorr, a substrate temperature greater than 150 degrees C. (e.g., 250 degrees C.), and a RF power source of 4000 to 6000 watts.

In an embodiment, program code instructions 519 include instructions that cause the gas distributor to introduce a second reactive gas mixture including a mixture of H₂ gas and another gas with no H₂O such as an inert process gas (e.g., argon, helium, xenon) to selectively remove the photoresist layer from the interconnect structure 290 during an over etch operation.

In a specific embodiment, the second reactive gas mixture removes the photoresist layer at an etch rate of 600 Angstroms per minute with a total gas flow rate between 2,500 and 12,500 sccm (e.g., 7500 sccm of helium gas, 1500 sccm of H₂ gas), a helium to hydrogen gas ratio between 1:1 and 10:1, a process chamber pressure of 50 mTorr to 3000 mTorr, a substrate temperature greater than 150 degrees C. (e.g., 250 degrees C.), and a RF power source of 4000 to 6000 watts.

In another embodiment, the instructions 515 or 519 include both instructions for the main and over etch operations as discussed above.

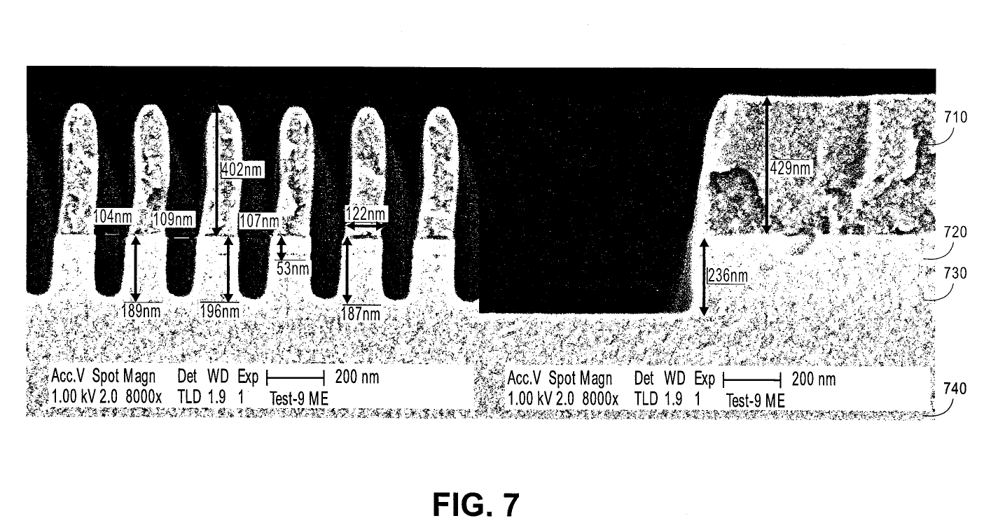

FIG. 7 illustrates a cross-sectional view of a trench structure after a trench etch in accordance with one embodiment. An ultra low-k trench structure is etched with a fluorocarbon plasma in an Applied Enabler™ Etch chamber. The etch structure includes a photoresist layer 710 having a thickness of approximately 430 nm disposed on top of a 60 nm oxide hard mask 720. The oxide hard mask 720 is disposed on a 500 nm porous ultra low-k material 730 that is disposed on a 70 nm barrier film (e.g., SiCN) that is disposed on a substrate (not shown). After etch, the substrate is transferred to a resist removal apparatus as illustrated in FIG. 4-6. In one embodiment, the resist removal apparatus is operated at a pressure less than 3 Torr (e.g., 1 Torr), a source power less than 5000 Watts in the presence of a H₂O/H₂ gas mixture followed by a H₂/He gas mixture. The substrate temperature is greater than 150 degrees C., typically 250 degrees C. The total gas mixture flow rate can be 100 to 10000 sccm.

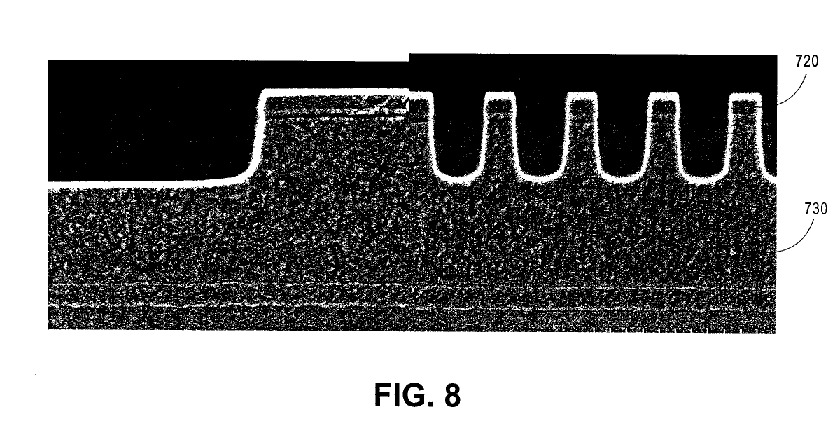

FIG. 8 illustrates a cross-sectional view of the trench structure illustrated in FIG. 7 after a resist removal in accordance with one embodiment. The resist removal is performed in a resist removal apparatus as illustrated in FIG. 4-6 with a H₂O/H₂ gas mixture followed by a H₂/He gas mixture. The damage to the ultra low-k material 730 is quantified as the difference in width of the oxide hard mask layer 720 and the minimum space between adjacent lines after staining the trench structure in dilute HF solution. Removing the resist in the resist removal apparatus does not damage and/or etch the ultra low-k material 730 because the ultra low-k material 730 has a similar profile and etch depth in both FIGS. 7 and 8.

In the following description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A method of removing a photoresist layer in the presence of a low dielectric constant (low-k) dielectric layer in a process chamber, comprising:
exciting a first mixture of gases comprising a ratio of a flow rate of reducing process gas to a flow rate of an oxygen-containing process gas that is between 1:1 and 100:1 to generate a first reactive gas mixture including reactive radical species, ions, and electrons;
flowing the first reactive gas mixture into a settling cavity of the process chamber, the ions combining with the electrons while the first reactive gas mixture is within the settling cavity; and
exposing the photoresist layer overlaying the low-k dielectric layer on a substrate in a exposing cavity of the process chamber to the first reactive gas mixture to selectively remove the photoresist layer from the dielectric layer, wherein the settling cavity is located remotely with respect to the exposing cavity, the first reactive gas mixture flows through openings in the settling cavity to the exposing cavity, and the first reactive gas mixture contains substantially no ions when the substrate is exposed to the first reactive gas mixture.

2. The method of claim 1 wherein the reducing process gas is H₂.

3. The method of claim 1 wherein the oxygen-containing process gas is vaporized water.

4. The method of claim 1 wherein the oxidizing process gas substantially increases the rate of photoresist removal when compared with the reducing process gas alone.

5. The method of claim 1 wherein the first reactive gas mixture removes the photoresist layer at a rate of approximately 1.5 microns/minute.

6. The method of claim 1 wherein the ratio of the flow rate of the reducing process gas to the flow rate of the oxygen-containing process gas is approximately 55:1.

7. The method of claim 1 further comprising: heating the substrate prior to exposure to the first reactive gas mixture, the substrate being at a temperature between 150 degrees Celsius (C) and 400 degrees C. during exposure to the first reactive gas mixture.

8. The method of claim 1 further comprising:
exciting a second mixture of gases comprising a reducing process gas and a non-H₂O gas to generate a second reactive gas mixture including reactive radical species, ions, and electrons;
flowing the second reactive gas mixture into a settling cavity, the ions combining with the electrons while the second reactive gas mixture is within the settling cavity; and
exposing the photoresist layer overlaying the dielectric layer on the substrate in the exposing cavity to the second reactive gas mixture to selectively remove the photoresist layer from the low-k dielectric layer, wherein the settling cavity is located remotely with respect to the exposing cavity, the second reactive gas mixture flows through openings in the settling cavity onto the substrate, and the second reactive gas mixture contains substantially no ions when the substrate is exposed to the second reactive gas mixture.

9. The method of claim 8 wherein the reducing process gas is H₂.

10. The method of claim 8 wherein the non-H₂O gas is an inert process gas that comprises at least one of helium, argon, and xenon.

11. The method of claim 8 wherein the first gas mixture is a main etch operation and the second gas mixture is an over etch operation for removing the photoresist layer and any other organic layer in the presence of the low-k dielectric layer without damaging the low-k dielectric layer.

12. The method of claim 1 wherein the low-k dielectric layer has a dielectric constant less than 2.3, a porosity greater than twenty percent, and contains greater than ten percent Carbon.

13. An apparatus comprising:
(a) a substrate processing apparatus comprising a settling cavity and an exposure cavity having a substrate support to receive a substrate;
(b) a gas supply apparatus to distribute a first mixture of gases having a ratio of a flow rate of reducing process gas to a flow rate of an oxygen-containing process gas that is between 1:1 and 100:1 to generate a first reactive gas mixture including reactive radical species, ions, and electrons in the settling cavity; and
(c) an apparatus for generating radical species to energize the first mixture of gases including reactive radical species, ions, and electrons in the settling cavity, wherein the settling cavity is located remotely with respect to the exposure cavity having the substrate, the first reactive gas mixture flows through a baffle from the settling cavity to the exposure cavity onto the substrate to selectively remove a photoresist layer from a dielectric layer, and the first reactive gas mixture contains substantially no ions when the substrate is exposed to the first reactive gas mixture.

14. The apparatus of claim 13 wherein the reducing process gas is H₂ and the oxygen-containing process gas is vaporized water.

15. The apparatus of claim 13 wherein the first reactive gas mixture removes the photoresist layer at a rate of approximately 1.5 microns/minute.

16. The apparatus of claim 13 wherein the ratio of the flow rate of the reducing process gas to the flow rate of an oxygen-containing process gas is approximately 55:1.

17. The apparatus of claim 13 wherein the gas supply apparatus to distribute a second mixture of gases comprising a reducing process gas and a non-H₂O gas and the apparatus for generating radical species to energize the second reactive gas mixture including reactive radical species, ions, and electrons in the settling cavity.

18. The apparatus of claim 17 wherein the second reactive gas mixture flows through the baffle from the settling cavity to the exposure cavity onto the substrate to selectively remove the photoresist layer from the dielectric layer, and the second reactive gas mixture contains substantially no ions when the substrate is exposed to the first reactive gas mixture.

19. The apparatus of claim 18 wherein the reducing process gas is H₂.

20. The apparatus of claim 18 wherein the non-H₂O gas is an inert process gas that comprises at least one of helium, argon, and xenon.
